(19) United States
(12) Patent Application Publication
(10) Pub. No.: US 2002/0132879 A1
(43) Pub. Date: Sep. 19, 2002

(54) Tacky ink pen

(76) Inventor: Han-Shin Jung, Taejeon-city (KR)

Correspondence Address: FULWIDER PATTON LEE & UTECHT, LLP, 200 OCEANGATE, SUITE 1550, LONG BEACH, CA, 90802, US

(21) Appl. No.: 10/081,448

(22) Filed: Feb. 21, 2002

Related U.S. Application Data
(62) Division of application No. 09/764,491, filed on Jan. 17, 2001.

(30) Foreign Application Priority Data
Jan. 19, 2000 (KR) 2000-2411
Jan. 20, 2000 (KR) 2000-1552

(51) Int. Cl. C03C 17/00; C09D 11/00

(52) U.S. Cl. 523/160; 523/161

(57) ABSTRACT

A tacky ink includes a solvent, a coloring agent, and additives with a tackiness agent. The tackiness agent is to impart tackiness to the ink composition. The tackiness agent is polyethylene oxide with the following structural formula: HO—(CH₂CH₂O)ₙ—CH₂CH₂OH where n is ranged from 400 to 1,000,000.

### BACKGROUND OF THE INVENTION

(a) Field of the Invention

The present invention relates to a tacky ink and a pen using the same and, more particularly, to a pen using a tacky ink which can be used for various purposes with high tackiness.

(b) Description of the Related Art

Generally, tackiness refers to the property of ink that is elongated in a threadlike manner. When a pen is put on the paper while outputting ink, and withdrawn from the paper, the ink is linearly elongated between the pen and the paper.

In case the pen bears high tackiness, the desired lines or letters cannot be clearly drawn or written while leaving out unwanted portions on the paper. Therefore, the ink for writing should bear lower tackiness.

Recently, various kinds of pens have been developed to be used for various purposes. For instance, fluorescent pens are used to give prominence to important or desired portions, and phosphorescent pens are used in dark areas.

In this connection, the pens bearing high tackiness may be well adapted to be used for such purposes.

### SUMMARY OF THE INVENTION

It is an object of the present invention to provide a tacky ink which can be well adapted for use in various kinds of special-purpose pens.

This and other objects may be achieved by a tacky ink with the following features.

The tacky ink is formed with a solvent, a coloring agent, and additives containing a tackiness agent. The tackiness agent is to impart tackiness to the ink composition.

The tackiness agent is polyethylene oxide with the following structural formula: HO—(CH₂CH₂O)ₙ—CH₂CH₂OH where n is ranged from 400 to 1,000,000, more particularly ranged from 100,000 to 300,000.

The amount of the tackiness agent is 0.01-20 weight percents, more particularly 0.1-10 weight percents, of the ink composition.

The coloring agent is formed with one or more pigments soluble in the solvent such as oil pigment, water pigment, and fluorescent pigment, or with one or more kinds of particles distributed in the ink composition such as pigment or dye, metallic powder, mica powder, fluorescent dye, and phosphorescent dye. The additives include aromatic materials.

A pen using the tacky ink includes an ink storage unit with a tube for storing the tacky ink therein and a tip partially inserted into an end portion of the tube, a case receiving the ink storage unit, and a cap inserted into an end portion of the case while receiving the tip of the ink storage unit.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or the similar components, wherein:

FIG. 1 is an exploded perspective view of a pen using a tacky ink according to a preferred embodiment of the present invention;

FIG. 2 is a combinatorial sectional view of the pen shown in FIG. 1;

FIG. 3 illustrates the process of drawing the target figures with the pen shown in FIG. 1 containing the tacky ink;

FIG. 4 illustrates the figures drawn by the pen shown in FIG. 1; and

FIG. 5 illustrates the measurement of tackiness of the tacky ink for the pen shown in FIG. 1.

### DETAILED DESCRIPTION OF THE PREFERRED EMBODIMENTS

Preferred embodiments of this invention will be explained with reference to the accompanying drawings.

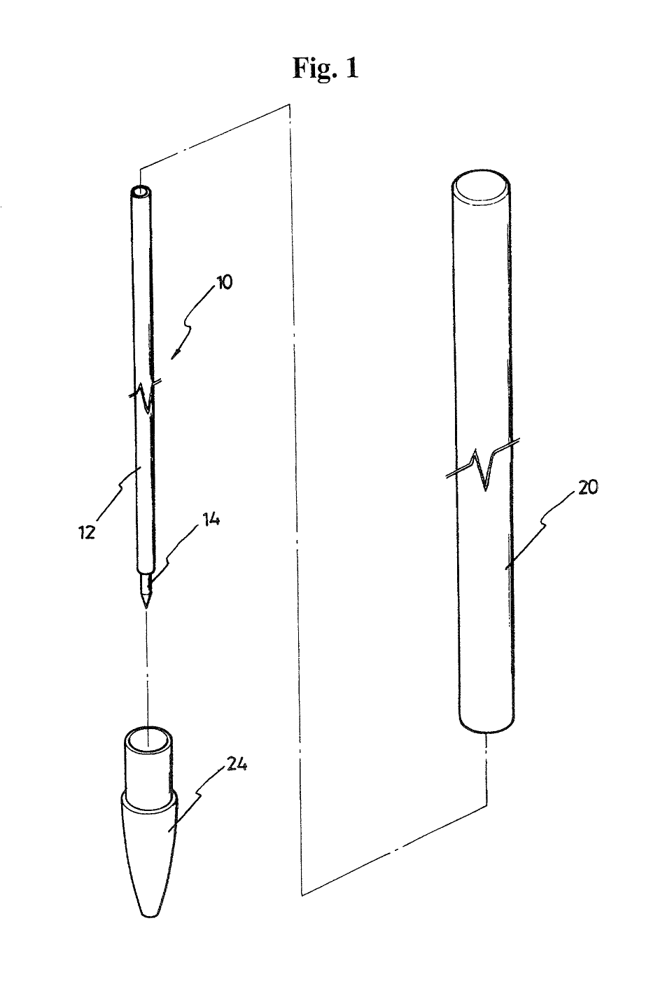

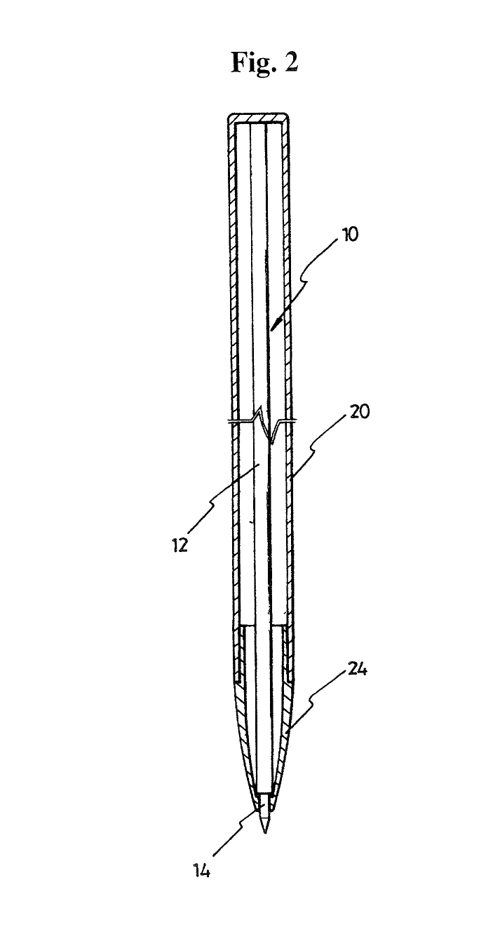

FIG. 1 is an exploded perspective view of a pen using a tacky ink according to a preferred embodiment of the present invention, and FIG. 2 is a combinatorial sectional view of the pen shown in FIG. 1.

As shown in the drawings, the pen includes an ink storage unit 10 with a tube 12 for storing a tacky ink therein and a tip 14 partially inserted into an end portion of the tube 12, a case 20 receiving the ink storage unit 10, and a cap 24 inserted into an end portion of the case 20 while receiving the tip 14 of the ink storage unit 10.

The tacky ink for the above-structured pen contains a solvent, a coloring agent, and other additives. A tackiness agent is added to the ink composition to impart high tackiness thereto.

In this preferred embodiment, polyethylene oxide is used as the tackiness agent. The amount of addition of the tackiness agent is 0.01-20 wt % of the ink composition.

When the amount of the tackiness agent is less than 0.01 wt %, the desired degree of tackiness cannot be achieved. In contrast, when the amount exceeds 20 wt %, viscosity of the resulting ink product is extremely increased.

It is more preferable that the amount of addition of the tackiness agent should be in the range of 0.1-10 wt % of the ink composition.

The polyethylene oxide for the tackiness agent can be expressed by the following structural formula: HO—(CH₂CH₂O)ₙ—CH₂CH₂OH where n is ranged from 400 to 1,000,000, more particularly from 100,000 to 300,000. The polyethylene oxide is well solved in the solvent while imparting high tackiness to the resulting ink product.

The solvent may be selected from water, alcohol such as ethanol, propanol, isopropanol, butanol and isobutanol, glycol ether such as methyl glycol, butyl glycol, propylene glycol monomethyl ether and propylene glycol monoethyl ether, ester such as butyl acetate and ethyl acetate, or ketone such as methyl ethyl ketone and methyl isobutyl ketone.

The amount of the solvent is preferably in the range of 10-80 wt % of the ink composition, more preferably in the range of 30-50 wt %.

One or more pigments soluble in the solvent such as oil pigment, water pigment and fluorescent pigment may be added to the composition as the coloring agent. It is also possible that one or more kinds of particles of pigment, dye, metallic powder, mica powder, fluorescent dye or phosphorescent dye may be uniformly distributed in the composition as the coloring agent.

The amount of the coloring agent is preferably in the range of 1-30 wt % of the ink composition, more preferably in the range of 3-15 wt %.

Furthermore, fluorescent or phosphorescent material, metallic powder or titanium dioxide may be added to the ink composition together with the coloring agent, or in a separate manner.

Resin, a humidity agent, a surface active agent, an antiseptic agent, an antirust agent or a pH-controlling agent may be further added to the ink composition.

In addition, a small amount of aromatic material may be added to the ink composition.

For example, the aromatic material may be selected from linden flower, licorice, pereirian, peppermint, lavender, lemongrass, mint, thyme, rosemary, mate, marigold, orange peel, wild strawberry, orange blossom, sage, basil, rosepink, marrow, black tea, jasmine, valerian, bergamot, camomile roman, cedarwood verginia, cinnamon, clary sage, cypress, eucalyptus, fennel, frankincense, geranium, grapefruit, hyssop, juniper, lemon, lime, marjoram, myrrh, palmarosa, patchouli, rose absolute, sandalwood, tea-tree, ylang ylang, ginger, rose, or cardamom.

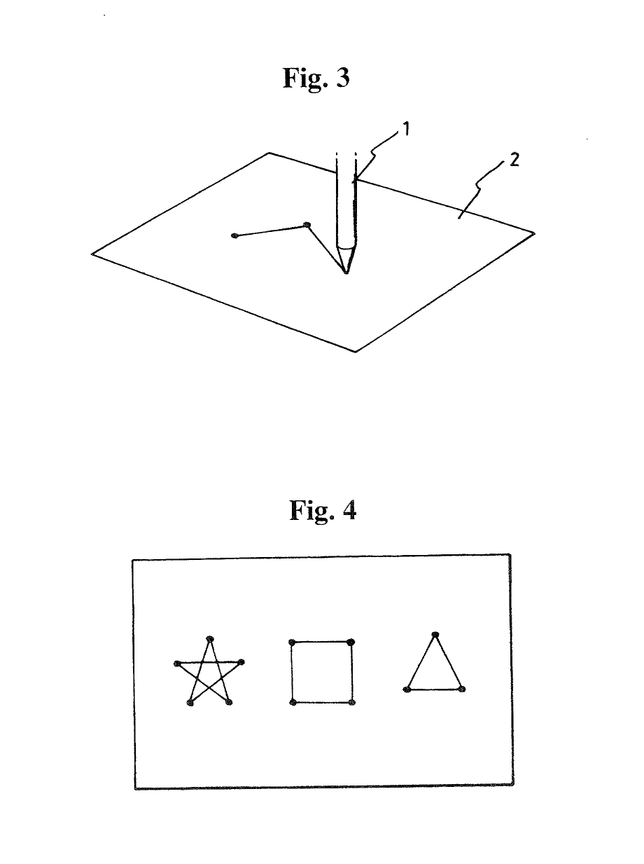

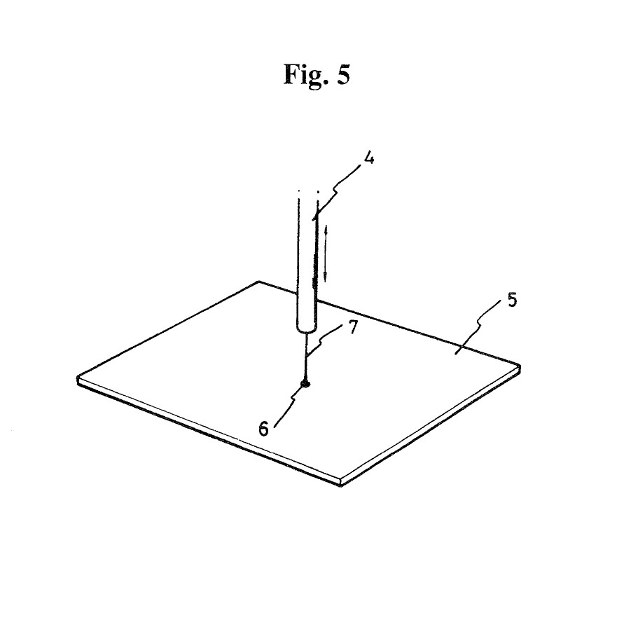

FIG. 3 illustrates the process of drawing the target figures with the pen 1 containing the tacky ink, and FIG. 4 illustrates the resulting figures.

As shown in the drawings, the pen 1 is put on a paper 2 for a while while forming a dot there, and moves by a predetermined distance while being withdrawn from the paper 2. This process is repeated to thereby complete the target figures.

Since the tacky ink bears high tackiness, a threadlike line is drawn on the paper 2 during the movement of the pen 1, and continuously proceeds up to the next dot so that the desired figure can be completed in a stable manner. Various kinds of pens may be designed with the use of such a tacky ink bearing high tackiness.

The following examples further illustrate the present invention.

### EXAMPLE 1

A fluorescent ink composition of a color of blue was prepared through mixing 50 wt % of water for a solvent, 20 wt % of glycerin for a humidity agent, 20 wt % of fluorescent dye (Victoria Blue G-28) for a coloring agent, 0.3 wt % of benzotriazole for an antiseptic agent, and 5.7 wt % of polyethylene oxide for a tackiness agent at an ambient temperature for one hour with the use of a high speed homo-mixer.

### EXAMPLE 2

An ink composition of a color of black was prepared through mixing 64 wt % of water for a solvent, 20 wt % of glycerin for a humidity agent, 10 wt % of dye (MA-100) for a coloring agent, 0.3 wt % of benzotriazole for an antiseptic agent, and 5.7 wt % of polyethylene oxide for a tackiness agent at an ambient temperature for one hour with the use of a high speed homo-mixer.

### Comparative Example 1

An ink composition of a color of black was prepared through mixing 64 wt % of water for a solvent, 20 wt % of glycerin for a humidity agent, 10 wt % of dye (MA-100) for a coloring agent, 0.3 wt % of benzotriazole for an antiseptic agent, and 5.7 wt % of Arabia gum for a viscosity agent at an ambient temperature for one hour with the use of a high speed homo-mixer.

The resulting ink compositions in the Examples 1 and 2 and the Comparative Example 1 were measured in the aspects of the time period and the length of tackiness. The measurement results are listed in Table 1.

The measurement was made in the following way. As shown in FIG. 5, 1 g of the ink composition 6 was put on a glass plate 5, and a plastic bar 4 with a diameter of 0.5 cm and a length of 10 cm was made to directly contact the ink composition 6 on the glass plate 5. One second later, the plastic bar 4 was hold up by the height of 5 cm from the glass plate 5 in a speed of 5 cm/s while forming an inky thread 7 between the plastic bar 4 and the ink composition 6 on the glass plate 5.

In the above condition, the time period of tackiness was obtained through measuring the time period for which the inky thread 7 is maintained without cutting, and the length of tackiness was obtained through measuring the length of the inky thread 7 without cutting.

TABLE 1

| | | | Comparative |
|---|---|---|---|
| | Example 1 | Example 2 | Example 1 |
| Time period of | 15 | 13 | 0 |
| tackiness | | | |
| (second) | | | |
| Length of | 17 | 15 | 1.8 |
| tackiness (cm) | | | |

As known from Table 1, the tacky inks according to the Examples 1 and 2 bear sufficient tackiness with the time period of ten (10) seconds or more and the length of 17 cm or more, whereas the tacky ink according to the Comparative Example 1 does not nearly bear tackiness.

As described above, the inventive tacky ink bears tackiness so high as to draw figures or special characters, and based on such a property, various kinds of pens can be developed.

For example, children may use the pens based on the tacky ink to draw pictures on wallpapers or cards, and this may serve to exert interest of the children and develop their intelligence.

Furthermore, in case fluorescent or phosphorescent materials are added to the ink composition, the resulting pictures are prominent to the naked eye at night so that the air of the room for children may be differentiated in various manners.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A tacky ink comprising:
a solvent;
a coloring agent; and
additives comprising a tackiness agent for imparting tackiness to the ink composition.

2. The tacky ink of claim 1 wherein the tackiness agent is polyethylene oxide.

3. The tacky ink of claim 2 wherein the polyethylene oxide is expressed by the following structural formula: HO—(CH₂CH₂O)ₙ—CH₂CH₂OH where n is ranged from 400 to 1,000,000.

4. The tacky ink of claim 2 wherein the polyethylene oxide is expressed by the following structural formula: HO—(CH₂CH₂O)ₙ—CH₂CH₂OH where n is ranged from 100,000 to 300,000.

5. The tacky ink of claim 1 wherein the amount of the tackiness agent is 0.01-20 weight percents of the ink composition.

6. The tacky ink of claim 1 wherein the amount of the tackiness agent is 0.1-10 weight percents of the ink composition.

7. The tacky ink of claim 1 wherein the coloring agent is formed with one or more pigments soluble in the solvent such as oil pigment, water pigment, and fluorescent pigment, or with one or more kinds of particles distributed in the ink composition such as pigment or dye, metallic powder, mica powder, fluorescent dye, and phosphorescent dye.

8. The tacky ink of claim 1 wherein the additives comprise aromatic materials.

9. A pen using a tacky ink, the pen comprising:
an ink storage unit with a tube for storing the tacky ink therein and a tip partially inserted into an end portion of the tube, the tacky ink having a composition of a solvent, a coloring agent and additives, the additives comprising a tackiness agent for imparting tackiness to the ink composition;
a case receiving the ink storage unit; and
a cap inserted into an end portion of the case while receiving the tip of the ink storage unit.

10. The tacky ink of claim 9 wherein the tackiness agent is polyethylene oxide.

11. The tacky ink of claim 10 wherein the polyethylene oxide is expressed by the following structural formula: HO—(CH₂CH₂O)ₙ—CH₂CH₂OH where n is ranged from 400 to 1,000,000.

12. The tacky ink of claim 9 wherein the amount of the tackiness agent is 0.01-20 weight percents of the ink composition.

13. The tacky ink of claim 9 wherein the coloring agent is formed with one or more pigments soluble in the solvent such as oil pigment, water pigment, and fluorescent pigment, or with one or more kinds of particles distributed in the ink composition such as pigment or dye, metallic powder, mica powder, fluorescent dye, and phosphorescent dye.
